(19) United States
(12) Patent Application Publication
(10) Pub. No.: US 2026/0369567 A1
(43) Pub. Date: Nov. 19, 2026

(54) SECONDARY BATTERY

(71) Applicant: SAMSUNG SDI CO., LTD., Yongin-si (KR)

(72) Inventor: Young Kwang YUN, Yongin-si, Gyeonggi-do (KR)

(21) Appl. No.: 19/420,975

(22) Filed: Dec. 16, 2025

(30) Foreign Application Priority Data
Apr. 18, 2025 (KR) 10-2025-0050592

(51) Int. Cl. H01M 4/36; H01M 4/02; H01M 4/131; H01M 4/505; H01M 4/525; H01M 50/105

(52) U.S. Cl. CPC H01M 4/366; H01M 4/131; H01M 4/505; H01M 4/525; H01M 50/105; H01M 2004/021; H01M 2004/028

(57) ABSTRACT

The present disclosure relates to a secondary battery. The secondary battery includes a positive electrode plate in which both a first positive electrode active material and a second positive electrode active material are laminated on different areas of a positive electrode base material, a negative electrode plate corresponding to the positive electrode plate, and a separator between the positive electrode plate and the negative electrode plate. The first positive electrode active material has superior output characteristics in comparison to the second positive electrode active material. And the second positive electrode active material has high-temperature storage characteristics in comparison to the first positive electrode active material.

### CROSS-REFERENCE TO THE RELATED APPLICATION

The present application claims priority to and the benefit of Korean Patent Application No. 10-2025-0050592, filed on Apr. 18, 2025, in the Korean Intellectual Property Office, the entire disclosure of which is incorporated herein by reference.

### BACKGROUND

### 1. Field

Aspects of the present disclosure relate to a secondary battery.

### 2. Description of the Related Art

Unlike a primary battery that cannot be charged, a secondary battery is a rechargeable and dischargeable battery. A low-capacity secondary battery may be used for various portable small-sized electronic devices, such as a smartphone, a feature phone, a notebook computer, a digital camera, or a camcorder, and a high-capacity secondary battery is widely used as a power source for motor drives, such as those in hybrid vehicles or electric vehicles. The secondary battery includes an electrode assembly consisting of a positive electrode and a negative electrode, a case accommodating the same, and electrode terminals connected to the electrode assembly.

The above information disclosed in this Background section is only for enhancement of understanding of the background of the disclosure and therefore it may contain information that does not constitute prior art.

### SUMMARY

Aspects of the present disclosure provide a secondary battery that has a structure in which positive electrode active materials having different characteristics are laminated to secure high-output performance and high-temperature storage stability in the secondary battery.

Aspects of the present disclosure also provide a secondary battery, in which an active material laminated on a specific area of a positive electrode base material is has composition and arrangement to minimize a difference in charge between electrodes during charging and discharging processes and to further improve efficiency and stability of the battery.

However, the technical problems to be achieved in some embodiments of the disclosure are not limited to the technical problems mentioned above, and other technical problems not mentioned herein will be clearly understood from the following description by those skilled in the art to which the disclosure belongs.

A secondary battery includes: a positive electrode plate in which a first positive electrode active material and a second positive electrode active material are laminated on different areas of a positive electrode base material; a negative electrode plate corresponding to the positive electrode plate; and a separator between the positive electrode plate and the negative electrode plate, wherein the first positive electrode active material has superior output characteristics compared to the second positive electrode active material, and the second positive electrode active material has high-temperature storage characteristics in comparison to the first positive electrode active material.

According to some embodiments, the secondary battery may further include a positive electrode tab connected to the positive electrode base material. The first positive electrode active material may be laminated on a first area of the positive electrode base material connected to the positive electrode tab. The second positive electrode active material may be laminated on a second area disposed below the first area. The first area may be set along a width direction of the positive electrode base material, and the first area is positioned closer to the positive electrode tab than the second area is to the positive electrode tab. The first positive electrode active material may also be laminated along a width direction of the positive electrode base material.

According to some embodiments, the first positive electrode active material may be positioned to the positive electrode tab than the second positive electrode active material is to the positive electrode tab. The first positive electrode active material may further include at least one of nickel-cobalt-aluminum oxide (NCA) or nickel-cobalt-manganese oxide (NCM). And the second positive electrode active material may include lithium cobalt oxide (LCO).

According to some embodiments, the secondary battery may further include: a first active material layer in which the first positive electrode active material is laminated on the first area; and a second active material layer in which the second positive electrode active material is laminated on the second area. A thickness of the first active material layer laminated on the positive electrode base material may be thinner than a thickness of the second active material layer. The thickness of the first active material layer may be about 70% to about 80% of the thickness of the second active material layer. A vertical length of the first active material layer may be shorter than a vertical length of the second active material layer. And, when a vertical length of the first active material layer is L1, and a vertical length of the second active material layer is L2, a conditional expression of L1<(L1+L2)*0.4 may be satisfied.

A secondary battery according to some embodiments of the present disclosure includes: a case, an electrode assembly accommodated in the case, the electrode assembly including a positive electrode plate, with the positive electrode plate including a first positive electrode active material and a second positive electrode active material are laminated on different areas of a positive electrode base material, a negative electrode corresponding to the positive electrode plate, and a separator disposed between the positive electrode plate and the negative electrode plate; an electrode tab including a positive electrode tab connected to the positive electrode plate and a negative electrode tab connected to the negative electrode plate, wherein the first positive electrode active material has superior output characteristics compared to the second positive electrode active material, and the second positive electrode active material has high-temperature storage characteristics compared to the first positive electrode active material.

According to some embodiments, the case may include a pouch formed from a soft film. The first positive electrode active material may include at least one of nickel-cobalt-aluminum oxide (NCA) or nickel-cobalt-manganese oxide (NCM). The second positive electrode active material may include lithium cobalt oxide (LCO). The first positive electrode active material may be laminated on a first area of the positive electrode base material connected to the positive electrode tab, and the second positive electrode active material may be laminated on a second area below the first area.

According to some embodiments, the secondary battery may further include: a first active material layer in which the first positive electrode active material is laminated on the first area; and a second active material layer in which the second positive electrode active material is laminated on the second area. The first active material layer may be laminated on each of both surfaces of the positive electrode base material, and the second active material layer may also be laminated on each of both the surfaces of the positive electrode base material. The thickness of the first active material layer may be about 70% to about 80% of the thickness of the second active material layer. And, when a vertical length of the first active material layer is L1, and a vertical length of the second active material layer is L2, a conditional expression of L1<(L1+L2)*0.4 may be satisfied.

### BRIEF DESCRIPTION OF THE DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings.

FIG. 1 illustrates a secondary battery;

FIG. 2 illustrates the secondary battery;

FIG. 3 illustrates an electrode assembly;

FIG. 4 illustrates a first view of a positive electrode plate;

FIG. 5 illustrates a second view of a positive electrode plate;

FIG. 6 illustrates a third view of a positive electrode plate;

FIG. 7 illustrates a fourth view of a positive electrode plate;

FIG. 8 illustrates a fifth view of a positive electrode plate;

FIG. 9 illustrates a sixth view of the positive electrode plate;

FIGS. 10 and 11 illustrate views of a battery pack including an exemplary secondary battery; and

FIGS. 12 and 13 illustrate views of a vehicle including an exemplary battery pack.

### DETAILED DESCRIPTION OF EXEMPLARY EMBODIMENTS

Hereinafter, the present disclosure will be described in detail. Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe the disclosure in the best way possible. Therefore, some embodiments described in the specification and the configurations described in the drawings are only the most preferred embodiments of the present disclosure, and do not represent all of the technical ideas of the present disclosure. It is to be understood that there may be various equivalents and variations in place of them at the time of filing the present application. In addition, as used herein, the terms ““comprise or include”” and/or “comprising or including,” when used in this specification, specify the presence of stated features, numbers, steps, operations, elements, and/or components, but do not preclude the presence or addition of one or more other features, numbers, steps, operations, elements, components, and/or groups thereof. In addition, when describing embodiments of the present disclosure, “can” and “may” may include “one or more embodiments of the present disclosure.”

In addition, for a better understanding of the invention, The attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, each component may be singular or plural, unless the context clearly indicates otherwise.

The arrangement of an arbitrary component on the “upper portion (or lower portion)” or “upper (or lower) portion” of a component means that an arbitrary component is placed in contact with the upper (or lower) surface of the component. In addition, it may mean that other components may be interposed between the component and any component disposed on (or under) the component.

Also, it will be understood that when an element is referred to as being “connected to,” “coupled to,” or “linked to” another element, these elements can be directly connected or coupled to each other, another intervening element may be present therebetween, or the respective elements may be connected, coupled, or linked to each other through another elements.

Throughout the specification, the expression “A and/or B” means A, B, or A and B, unless otherwise defined. That is, as used herein, the term “and/or” includes any and all combinations of one or more of the associated listed items. The expression “C to D” means C or more and D or less, unless otherwise defined.

As used herein, the terms are for describing embodiments of the present disclosure and are not intended to limit the disclosure.

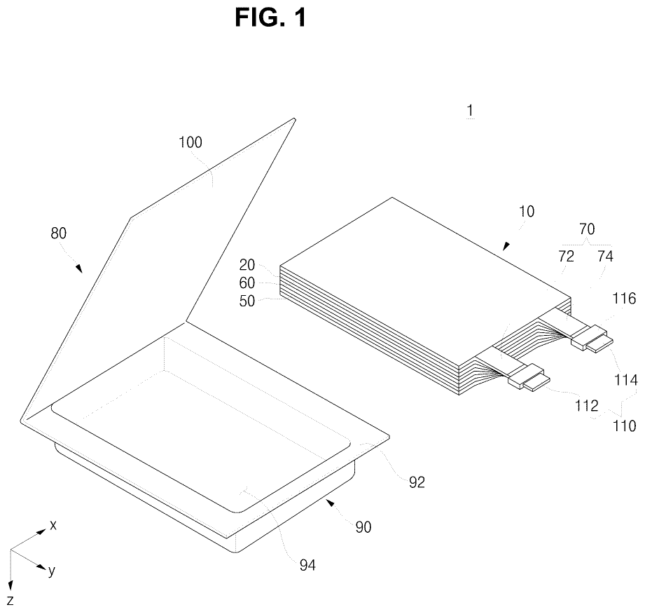

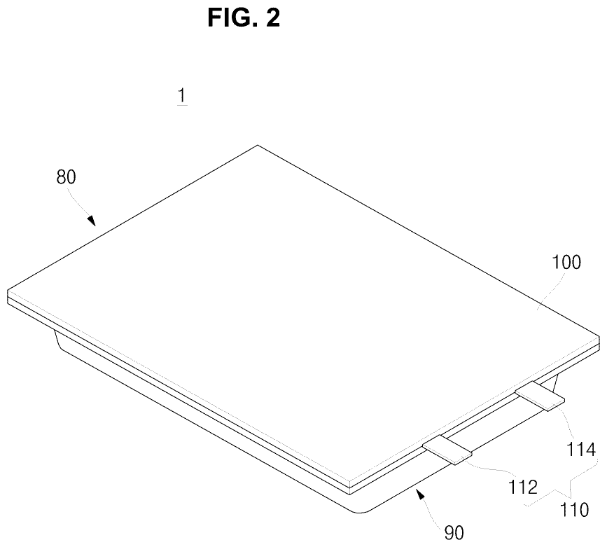

FIG. 1 illustrates an exploded perspective view of a secondary battery 1 according to embodiments. FIG. 2 illustrates a perspective view of the secondary battery 1 according to embodiments. FIG. 4 illustrates a perspective view of a positive electrode plate 20 according to embodiments. As illustrated in FIGS. 1, 2, and 4, the secondary battery 1 may include an electrode assembly 10 and a case 80. In some embodiments, the secondary battery 1 may further include an electrode lead 110 and an insulating tape 116.

In the present disclosure, a vertical direction y is defined along a long side of the case 80, and a width direction x is defined along a short side of the case 10 that intersects perpendicularly with the vertical direction y. A height direction z is defined as a direction that intersects perpendicularly with the vertical direction y and the width direction x. The vertical direction y is referred to as a first direction, the width direction x is referred to as a second direction, and the height direction z is referred to as a third direction.

The present disclosure relates to the secondary battery 1 capable of securing high-output performance and high-temperature storage stability. Additionally, the present disclosure may provide a positive electrode plate on which each of a positive electrode active material for improving output characteristics, and provides a positive electrode active material for improving high-temperature storage characteristics is laminated on different areas of the positive electrode base material 25. Further, a composition and arrangement of the active material laminated on a specific area of the positive electrode base material 25 may minimize a difference in charge between the electrodes during a charging and discharging process and improve efficiency and stability of the battery.

The present disclosure also provides a structure in which the positive electrode active materials having different characteristics are laminated to simultaneously secure high-output performance and high-temperature storage stability in the secondary battery 1. As a result, limitations of the secondary battery 1 using an existing single active material may be overcome, and stable performance may be achieved in various applications requiring high output, such as power tools, vacuum cleaners, drones, and electric vehicles. In addition, because the present disclosure may be applied to a pouch-type structure using a soft film, it may be used in various types of battery products and may provide stable power supply, while maintaining high energy density.

The electrode assembly 10 may include a positive electrode plate 20, a negative electrode plate 50, and a separator 60. The electrode assembly 10 may be provided in a stack configuration where the positive electrode plate 20, the negative electrode plate 50, and the separator 60 are alternately stacked. In one set of example embodiments, the electrode assembly 10 may be provided in the form of a roll in which a negative electrode part, a positive electrode part, and the separator 60 are wound. In other embodiments, the electrode assembly 10 may be provided in the form of a roll in which the negative electrode part, the positive electrode part, and the separator 60 are wound in a multi-tap winding manner.

The electrode assembly 10 according to embodiments may be provided with an electrode tab 70 that is accommodated in the case 80. Further, the electrode assembly 10 is provided with the positive electrode plate 20, the negative electrode plate 50, and the separator 60 between the positive electrode plate 20 and the negative electrode plate 50, in one direction. Herein, the case 80 may be referred to as a pouch.

The electrode assembly 10 may be accommodated inside the pouch together with an electrolyte. The electrolyte may be provided as a combination of an organic solvent and a lithium salt. The organic solvent may include ethylene carbonate (EC), propylene carbonate (PC), diethyl carbonate (DEC), ethyl methyl carbonate (EMC), and dimethyl carbonate (DMC), but is not limited thereto. The lithium salt may include lithium hexafluorophosphate (LiPF6) or lithium tetrafluoroborate (LiBF4). In addition, the electrolyte may be provided as an appropriate composition in consideration of electrical and chemical reactivity with the electrode.

The positive electrode plate 20 may be provided in the form of a plate made of aluminum (Al) and coated with transition metal oxide on at least one surface of the positive electrode plate 20. In some examples, a positive electrode non-coating portion is a portion on which the positive electrode active material is not provided. The positive electrode non-coating portion may be provided at one side of the positive electrode plate 20.

The negative electrode plate 50 may be position to correspond to the positive electrode plate 20. The negative electrode plate 50 may be provided in the form of a plate made of copper (Cu) or nickel (Ni) and may be coated with a negative electrode active material, such as graphite or carbon on at least one surface thereof. In some examples, a negative electrode non-coating portion is where the negative electrode active material is not provided. The positive electrode non-coating portion may be provided at one side of the negative electrode plate 50.

The separator 60 may be positioned or located between the positive electrode plate 20 and the negative electrode plate 50. The separator 60 may also be made of polyethylene (PE) or polypropylene (PP), but the present disclosure is not limited thereto. The separator 60 may prevent an electrical short between the positive electrode plate 20 and the negative electrode plate 50, and the separator 60 may allow movement of lithium ions between the plates 20 and 50.

The electrode tab 70 may include a positive electrode tab 72 and a negative electrode tab 74. The positive electrode plate 20 may be provided with the positive electrode tab 72 electrically connected to a positive electrode non-coating portion. The negative electrode plate 50 may be provided with the negative electrode tab 74 electrically connected to a negative electrode non-coating portion. The electrode tab 70 may be welded to the electrode lead 110 and electrically connected to the outside. The insulating tape 116 may be attached to the electrode lead 110 and provide insulation from the pouch. The positive electrode tab 72 may be connected to the positive electrode base material 25 of the positive electrode plate 20. The negative electrode tab 74 may be connected to a negative electrode base material of the negative electrode plate 50. The positive electrode tab 72 may be attached to the positive electrode plate 20 by welding, and various modifications may be performed, such as the non-coating portion of the positive electrode plate 20 being processed into the positive electrode tab 72.

The case 80 may accommodate the electrode assembly 10 and be sealed with the electrode lead 110 extended to the outside. The case 80 may be various shapes that surround the outside of the electrode assembly 10. In the present disclosure, the case 80 may use a pouch made of a soft film. The pouch may be provided with a case body 90 and a case cover 100 by folding a rectangular film extending in the vertical direction y.

After the electrode assembly 10 is accommodated in a recess 94 provided in the case body 90, the case cover 100 may rotate to close an open entrance of the case body 90. In the present disclosure, the pouch is not limited to the integrated form in which both the case body 90 and the case cover 100 are on a single film. However, for the sake of explanation, the following description will be given as an example in which the case body 90 and the case cover 100 are on a single rectangular film.

In some embodiments, the case body 90 may include the recess 94 and a sealing part 92. The case body 90 may be provided with the recess 94, in which the electrode assembly 10 is accommodated at the center or approximately near the center, and may include the sealing part 92 extending approximately outward from three sides of the recess 94.

The sealing part 92 may be a surface that is parallel to and coupled to the case cover 100. In one example, if the case body 90 and the case cover 100 are provided as separate members, the sealing part 92 may extend outward from the four sides of the recess 94. In another example, even if the case body 90 and the case cover 100 are integrated with each other, the sealing part 92 may extend outward from the four sides of the recess 94.

The case cover 100 and the case body 90 may be provided as a multilayer thin film including a metal thin film and insulating layers, which are located on one side and the other side of the metal thin film. The case cover 100 and the case body 90 may define surfaces that are in contact with each other as inner surfaces, and opposite surfaces as outer surfaces.

The recess 94 of the case body 90 may be provided in a size that is enough to accommodate the electrode assembly 10 (e.g., through pressing or drawing processing, etc.). In the case body 90, an edge of the recess 94 and an edge of the case cover 100 may be thermally fused to each other, after the case cover 100 covers the portion in which the recess 94 is defined. The pouch may be sealed by sealing an edge area of the case body 90 and an edge area of the case cover 100, after the electrode assembly 10 is accommodated in the recess 94.

For the sake of convenience, the edge of the case body 90 on the outer side of a plane may be defined as the sealing part 92. The edge of the case body 90 may also be positioned with respect to the recess 94 that is sealed with the edge of the case cover 100. An inner surface of the pouch may have a thermal fusion layer made of a thermal fusion material.

The case cover 100 may have a rectangular flat shape. The case cover 100 may also be connected to the case body 90 to cover an upper portion of the case body 90 via a folding operation. The case cover 100 may further be modified in various manners, such as by defining a groove for accommodating the electrode assembly 10 together with the case body 90.

The electrode lead 110 may be electrically connected to the electrode assembly 10. One side of the electrode lead 110 may be electrically connected to the electrode tab 70 of the electrode assembly 10, and the other side of the electrode lead 110 may extend to the outside of the case 80. In some embodiments, the electrode lead 110 may include a positive electrode lead 112 (connected to the positive electrode tab 72) and a negative electrode lead 114 (connected to the negative electrode tab 74).

The insulating tape 116 may be between the electrode lead 110 and the case 80. The insulating tape 116 may also be deformed into various shapes within the technical concept of being fixed to the outside of the electrode lead 110. Further, the insulating tape 116 may be installed on each of both surfaces of the electrode lead 110 facing the case 80. Because the insulating tape 116 is installed, the electrical connection between the electrode lead 110 and the case 80 may be blocked.

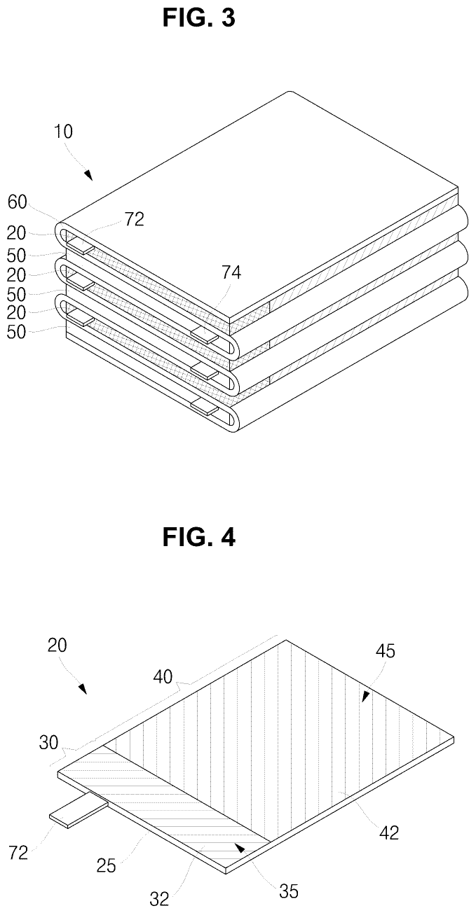

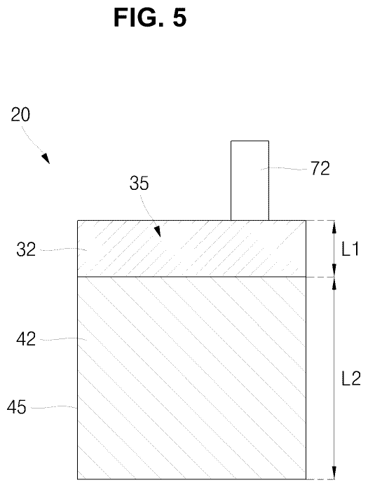

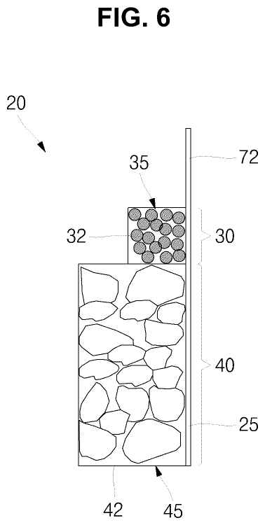

FIG. 3 is a perspective view of the electrode assembly 10 according to embodiments. FIG. 5 is a plan view of the positive electrode plate 20 according to embodiments. FIG. 6 is a side cross-sectional view of the positive electrode plate 20 according to embodiments. As illustrated in FIGS. 3, 5, and 6, the electrode assembly 10 may include the positive electrode plate 20, the negative electrode plate 50, and the separator 60 between the positive electrode plate 20 and the negative electrode plate 50.

The positive electrode plate 20 included in the electrode assembly 10 of the present disclosure may include a positive electrode base material 25, a first active material layer 35, and a second active material layer 45. The first active material layer 35 and the second active material layer 45 may have different electrochemical characteristics, and may be configured to exhibit optimal performance under specific charging and discharging conditions.

In some embodiments, the electrode assembly 10 may be accommodated in the pouch-type case 80 together with an electrolyte, and may be electrically connected to an external circuit through the electrode tab 70. The structural arrangement of the electrode assembly 10 may be designed to minimize internal resistance of the battery and improve charging and discharging efficiency of the battery.

The positive electrode plate 20 may include a structure in which a first positive electrode active material 32 for improving output characteristics and a second positive electrode active material 42 for improving high-temperature storage characteristics are laminated on different areas of the positive electrode base material 25, and various modifications are possible within the technical field of endeavor.

The first positive electrode active material 32 may have superior output characteristics compared to the second positive electrode active material 42. In the present disclosure, a reason the first positive electrode active material 32 having superior output characteristics compared to the second positive electrode active material 42 is the use of nickel-cobalt-aluminum oxide (NCA) or nickel-cobalt-manganese oxide (NCM). NCA and NCM may be capable of being used as the first positive electrode active material 32. NCA and NCM also have relatively superior electrical conductivity and a lithium ion diffusion speed compared to lithium cobalt oxide (LCO). In some embodiments, the NCA and NCM materials may provide high output performance by enabling activated lithium ions to move more quickly under a rapid charging/discharging environment, requiring a high-rate discharging (C-rate). The second positive electrode active material 42 may have superior high-temperature storage characteristics compared to the first positive electrode active material 32. A reason for the second positive electrode active material 42 having superior high-temperature storage characteristics compared to the first positive electrode active material 32 is because the structural stability of the LCO material is relatively superior under the high-temperature environment in comparison to the NCA or the NCM. The NCA and the NCM may have high gas generation under the high-temperature environment to cause structural limitations such as swelling, whereas the LCO may have low gas generation at a high temperature to maintain the structural stability for a longer period of time. Thus, in the present disclosure, the LCO may be laminated on a lower area of the positive electrode plate 20 to secure long-term stability under the high-temperature environment.

The positive electrode plate 20 of the present disclosure may be configured to maximize the performance of the battery by laminating the different active materials on the specific areas (first area 30 and second area 40) connected to the positive electrode tab 72. The active material having the high-output characteristics (e.g., NCA or NCM) may be on the first area 30, and the active material having the high-temperature storage stability (e.g., lithium cobalt oxide (LCO)) may be on the second area 40.

The first area 30 and the second area 40 may be configured to have different electrochemical properties depending on a distance from the positive electrode tab 72 to improve the charging distribution within the electrode during the charging and discharging and improve durability of the electrode. In some embodiments, the structure of the positive electrode plate 20 may be implemented by a single-layer coating manner and also by a multi-layer coating manner. The energy density of the battery may be improved by controlling a thickness and density of the positive electrode active material layer.

The positive electrode base material 25 may serve as a base material on which the positive electrode active material layer is laminated and may be made of a conductive material to facilitate a flow of electrons. In some examples, aluminum (Al) or an aluminum alloy may be used as the positive electrode base material 25 and may provide high electrical conductivity and chemical stability.

The positive electrode base material 25 may be subjected to surface treatment (e.g., etching or coating) to promote better adhesion with the active material layer and minimize internal resistance of the battery. In some examples, a thickness and surface roughness of the positive electrode base material 25 may affect the adhesion of the active material layer and the overall performance of the electrode. Thus, a specific manufacturing process may be applied.

A first positive electrode active material 32 having high-output characteristics may be laminated on the first area 30 of the positive electrode base material 25 connected to the positive electrode tab 72 to improve initial charging and discharging performance, as well as improve power-output characteristics of the battery. The first area 30 may be set along a width direction x of the positive electrode base material 25 and may be disposed in consideration of the distance from the positive electrode tab 72, in order to provide an electron movement path and reduce the internal resistance.

The first positive electrode active material 32 may be laminated on the first area 30 to provide the first active material layer 35. Additionally, the active material layer may be uniformly distributed along the width direction x of the positive electrode base material 25. The first positive electrode active material 32 may include at least one of NCA or NCM.

In some embodiments, the first positive electrode active material 32 may include one or more of NCA or NCM, and may constitute about 50% or more of the entire first positive electrode active material 32. As a result, high power density and excellent charging and discharging characteristics may be provided.

In some embodiments, the NCA and the NCM may have a characteristic which specifies that the energy density increases as an amount of nickel (Ni) increases. The embodiments may also include examples where the NCA and the NCM are the main components of the positive electrode active material, in order to maximize the energy storage capacity of the battery. As result, in the case of the NCM, thermal stability may be secured by adjusting the composition of cobalt (Co) and manganese (Mn). Further, the NCA may have high output characteristics to contribute to enhancement of the power performance of the battery.

In some embodiments of the present disclosure, the amount of NCA or NCM may be set to about 50% or more, a diffusion speed of lithium ions during the rapid charging may increase, and the internal resistance may be reduced to improve the charging and discharging efficiency of the battery. Consequently, the battery's output performance may increase, and also, stable performance may be maintained even under the high C-rate (charging and discharging speed) conditions.

Further, the composition of the first positive electrode active material 32 may improve the charge movement path within the electrode and suppress local potential concentration. This may reduce a deterioration rate of the electrode materials, improve long-term cycle stability, and provide an effect of extending a lifespan of the battery.

Thus, in the present disclosure, the NCA or the NCM may be provided as the main components of the first positive electrode active material 32 and be designed to be contained in about 50% or more to secure the high output performance, the high energy density, the rapid charging and discharging speed, the reduced internal resistance, and the long-term stability.

The second positive electrode active material 42 may be laminated on the second area 40 below the first area 30 to enhance the high-temperature storage characteristics, thereby improving the long-term durability of the battery and its performance under the high-temperature environment. Accordingly, the second positive electrode active material 42 laminated on the second area 40 may provide the second active material layer 45, and this layer may include an active material with high thermal stability to minimize thermal stress and structural deformation that may occur during the charging and discharging process. The second positive electrode active material 42 may include lithium cobalt oxide (LCO), and in some embodiments, the second positive electrode active material 42 may include more than 70% of LCO to maintain the high energy density, while ensuring the thermal stability.

The LCO may operate stably even at a high voltage, and a process of injecting or discharging lithium ions into/from the electrode may be smooth to allow for efficient storage and use of electricity. Thus, when the second positive electrode active material 42 contains LCO at about 70% or more, the total energy density of the battery may increase, and the stable voltage characteristics may be maintained even during the long-term use.

In some embodiments, the LCO may have high structural crystal stability and may effectively alleviate physical and chemical stress that occur during the charging and discharging process of the battery. In some embodiments, structural collapse may be minimized even under the high-temperature environment to suppress deterioration of the electrode materials and capacity reduction during the long-term use.

In the present disclosure, an amount of the LCO of the second positive electrode active material 42 may be set to about 70% or more, charge transfer within the electrode may be uniformly achieved, and the internal resistance of the battery may be reduced to maximize charging and discharging efficiency. The high thermal stability of the LCO may be used to alleviate the local heat concentration that may occur during the rapid charging and discharging, and the lifespan of the electrode may be extended.

Thus, in some embodiments of the present disclosure, the amount of the LCO of the second positive electrode active material 42 may be designed to maintain the high energy density, while ensuring safety during the charging and discharging process. As a result, the battery may maintain stable output even under the long-term use environment and provide excellent durability even under the high-temperature environment.

In some embodiments, the first positive electrode active material 32 may be closer to the positive electrode tab 72 than the second positive electrode active material 42 is to the positive electrode tab 72 to improve a current flow and uniformly adjust a potential difference between the electrodes. A thickness of the first active material layer 35 laminated on the positive electrode base material 25 may be thinner than a thickness of the second active material layer 45. And in some embodiments, the thickness of the first active material layer 35 may be within a range of about 70% to about 80% of the thickness of the second active material layer 45. The first active material layer 35 may be provided to be thinner than the second active material layer 45. And, thus, the current distribution within the electrode may be improved, and the internal resistance may be reduced. In one example, the area on which the first active material layer 35 may be located close to the positive electrode tab 72 and thus may be designed to provide fast charging and discharging characteristics, while having relatively low resistance. As a result, the output performance of the battery may be maximized, and the current density may be evenly distributed during the rapid charging.

In further embodiments, the thickness of the first active material layer 35 may be set to be in a range of about 70% to about 80% of the thickness of the second active material layer 45 to maintain an electrochemical balance within the electrode. This may contribute to alleviating of the potential difference between the electrodes during the charging and discharging process and may minimize deterioration and performance degradation of the electrode materials by preventing the local potential concentration.

Additionally, the thickness of the first active material layer 35 may be adjusted to provide a diffusion path of lithium ions within the electrode, thereby reducing the movement resistance of lithium ions and improving the charging and discharging efficiency. Due to the first active material layer 35 being provided relatively thinly, a volume expansion and contraction phenomena that may occur within the active material layer may be alleviated to assist the maintenance of the mechanical stability of the electrode.

In some embodiments, in a positive electrode structure of the present disclosure, the thickness of the first active material layer 35 may be set to be thinner than that of the second active material layer 45 to obtain various effects such as the improved battery output performance, the rapid charging and discharging speed, the reduced internal resistance, and the improved mechanical stability.

Additionally, a vertical length of the first active material layer 35 may be shorter than a vertical length of the second active material layer 45, and in some embodiments, a relationship between a vertical length L1 of the first active material layer 35 and a vertical length L2 of the second active material layer 45 may be designed to satisfy following conditional expression: L1<(L1+L2)×0.4. As a result, the charge distribution within the electrode may be maintained uniformly, and local overload occurring during the charging and discharging may be prevented.

The vertical length of the first active material layer 35 may be set to be shorter than that of the second active material layer 45, in order to uniformly maintain the charge distribution within the electrode. In one example, an upper area on which the first active material layer 35 may be located close to the positive electrode tab 72. And, thus, the current transfer may be smoothly achieved, and the internal resistance may be reduced, thereby securing the excellent electrical characteristics during the rapid charging and the high-power discharge.

In some embodiments, the vertical length of the first active material layer 35 may be limited to prevent the phenomenon of the current being concentrated into a specific area within the electrode during the charging and discharging process. In one example, because either the local potential increases or the current concentration within the electrode is alleviated, the material deterioration and the local overload that may occur due to the unbalanced lithium ion distribution within the electrode may be prevented.

In some embodiments, the length of the first active material layer 35 may be made to uniformly distribute the movement path of electrons and lithium ions within the electrode, thereby further reducing the internal resistance of the battery. As a result, not only the high-power performance but also the long-term cycle characteristics may be improved, and the mechanical stability of the electrode material may be maintained to improve the durability of the battery.

In the present disclosure, the vertical length of the first active material layer 35 may be designed to be shorter than that of the second active material layer 45. Additionally, the current and charge distribution within the electrode may be improved. Further, the local overload that may occur in a specific area within the electrode may be prevented to extend the lifespan of the battery and minimize the performance degradation.

The secondary battery 1 of the present disclosure may improve the performance of the battery by including the structure in which the first positive electrode active material 32 and the second positive electrode active material 42 (which have different electrochemical properties) are laminated on a specific area of the positive electrode base material 25. Consequently, the high-power performance and the high-temperature storage stability may be secured, and the charging and discharging efficiency may be maximized.

According to the present disclosure, the first positive electrode active material 32 may be close to the positive electrode tab 72 to provide the current transfer path and reduce the internal resistance, thereby providing the high power density. Additionally, the second positive electrode active material 42 may be on the lower area of the positive electrode plate 20 to improve the thermal stability under the high-temperature environment and secure the long-term reliability of the electrode.

According to embodiments of the present disclosure, the arrangement of the first and second positive electrode active materials 42 within the positive electrode plate 20 may be improved to prevent the local voltage imbalance, which may occur due to the potential difference during the charging and discharging process. Due to the first active material layer 35 being provided thinner than the second active material layer 45, the current distribution within the positive electrode may become uniform, and the mechanical stability of the electrode structure may be secured. Additionally, the arrangement and composition of the active materials on the first area 30 and the second area 40 may be made to prevent the material deterioration due to the repeated charging and discharging. Thus, the lifespan of the electrode material may be extended.

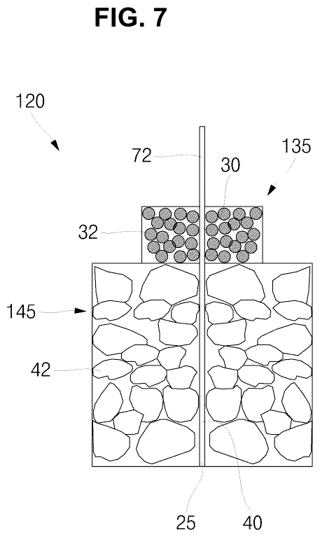

FIG. 7 is a side cross-sectional view of a positive electrode plate 120 according to other embodiments. As illustrated in FIG. 7, in a positive electrode plate 120 according to other embodiments, a first active material layer 135 may be laminated on each of both surfaces of a positive electrode base material 25, and a second active material layer 145 may also be laminated on each of both surfaces of a positive electrode base material 25.

The positive electrode plate 120 according to other embodiments may have the same configuration as the foregoing embodiment of the present disclosure, except that the first active material layer 135 and the second active material layer 145 are laminated on both the surfaces of the positive electrode plate 120.

The first active material layer 135 and the second active material layer 145 may be laminated on both the surfaces of the positive electrode base material 25 to increase in capacity, with respect to the electrode. Thus, energy density of the battery may be improved. Because the active material layer is uniformly laminated on both the surfaces of the positive electrode base material 25, a current flow may be uniformly distributed to prevent local current concentration within the electrode and improve the overall performance of the electrode.

In some embodiments, because both the surfaces of the positive electrode base material 25 are uniformly covered with the active material layer, mechanical strength of the electrode may increase to prevent the electrode from being damaged by an external impact or pressure and improve durability. Due to the active material being uniformly laminated on both the surface of the positive electrode base material 25, a movement path of ions and electrons within the electrode may be made to reduce internal resistance and improve charging and discharging efficiency. Further, due to the active material layer being distributed on both the surfaces, heat generated during the charging and discharging process may be distributed more evenly. As a result, local temperature rise may be suppressed, and thermal stability of the electrode may be improved.

The positive electrode plate 120 according to other embodiments may provide various effects such as increasing electrode capacity, maintenance of the current flow balance, improvement of mechanical strength, improvement of charging and discharging efficiency, reduction of internal resistance, and improvement of thermal stability, when the first active material layer 135 and the second active material layer 145 are laminated on both the surfaces of the positive electrode base material 25. A thickness ratio and a vertical length ratio of the first active material layer 135 and the second active material layer 145 may be the same as (or similar to) those presented for the foregoing embodiment, and thus, detailed descriptions thereof will be omitted.

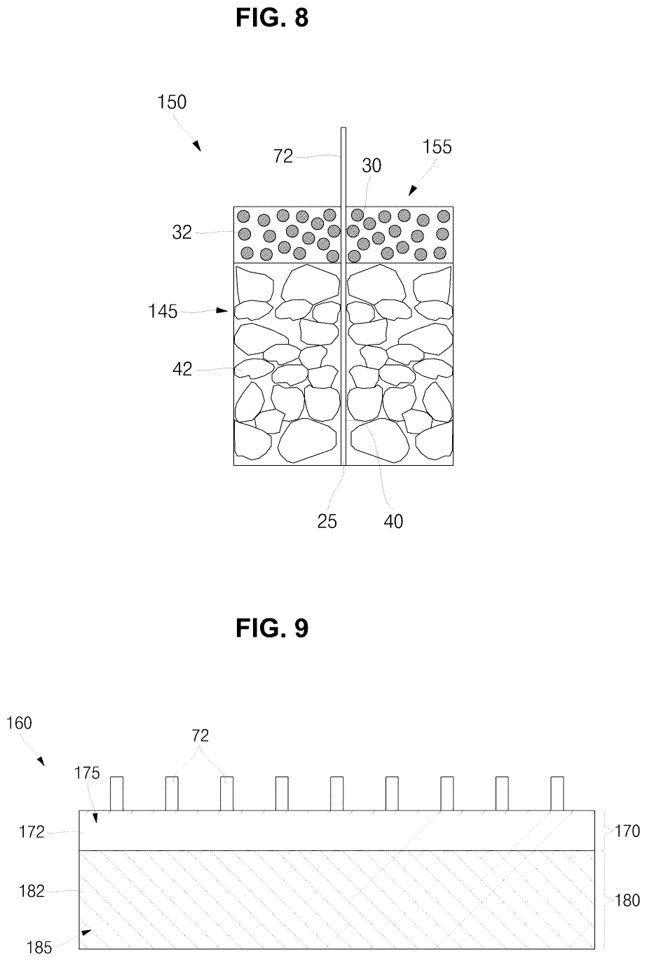

FIG. 8 is a side cross-sectional view of a positive electrode plate 150 according to other embodiments. As illustrated in FIG. 8, in the positive electrode plate 150, a thickness of a first active material layer 155 laminated on a positive electrode base material 25 may be of an amount equivalent to a thickness of a second active material layer 45. The thickness of the first active material layer 155 and the second active material layer 45 may be the same. A current flow within the electrode may be maintained uniformly. In addition, a phenomenon of current being concentrated in a specific area during a charging and discharging process may be prevented. As a result, local heat generation of the electrode may be reduced, and overall thermal stability of the battery may be improved.

In some embodiments, because the thicknesses of the first active material layer 155 and the second active material layer 45 are of a same amount. A diffusion distance of lithium ions within the positive electrode may be maintained constantly. And thus, electrode potential distribution may become uniform, and the charging and discharging efficiency of the battery may be improved. Additionally, the movement of lithium ions may be balanced during rapid charging to minimize voltage drop in a specific area within the electrode and reduce a rate of deterioration of electrode materials even under a long-term use environment.

Further, a vertical length ratio of the first active material layer 155 and the second active material layer 45 may be the same as or similar to that according to the foregoing embodiment, and thus, detailed descriptions thereof will be omitted. Finally, a thickness of the positive electrode active material layer may be adjusted to improved characteristics of the electrode so as to be suited for a specific application environment. In one example, to increase in energy density, the thickness of the second active material layer 45 may increase, or to maximize high-output performance, the thickness of the first active material layer 155 may increase.

In other embodiments, the first active material layer 155 and the second active material layer 45 may be provided to have the same amount of thickness, an effect of maintaining a uniform charge flow within the electrode, reducing local voltage drop, and simultaneously improving charging and discharging efficiency and thermal stability may be provided.

FIG. 9 is a front view of the positive electrode plate 160 according to other embodiments. As illustrated in FIG. 9, the positive electrode plate 160 according to other embodiments may be provided as a positive electrode plate 160 having a multi-tap winding structure.

The positive electrode plate 160 may extend along the width direction x, and the plurality of positive electrode tabs 72 may be installed at regular distances at an upper side of the positive electrode plate 160. The plurality of positive electrode tabs 72 may be provided to uniformly maintain the current density through the multi-tap structure, and the internal resistance may be reduced to improve the charging and discharging efficiency.

The upper area of the positive electrode plate 160 close to the positive electrode tab 72 may define a first area 170, and a second area 180 below the first area 170 may define a lower area of the positive electrode tab 72. In the first area 170, a first positive electrode active material 172 having excellent output characteristics may be laminated to form a first active material layer 175, and in the second area 180, a second positive electrode active material 182 having excellent high-temperature storage stability may be laminated to form a second active material layer 185. Because the first positive electrode active material 172 and the second positive electrode active material 182 are the same amount as (or a similar amount to) those presented for the foregoing embodiment, the detailed descriptions thereof will be omitted. In one example, the multi-tap structure may be applied to expect the effects of reducing the internal resistance of the electrode and optimizing the current distribution to improve the output performance and energy density of the battery.

In some embodiments, the positive electrode plate 160 may be designed in the multi-tap winding manner, and thus, the current flow may be maintained more uniformly. Especially, internal heat generation of the battery may be suppressed under the high-power discharging conditions, and local potential concentration that may occur at a specific electrode area may be prevented.

In other embodiments of the present disclosure, the multi-tap structure may be introduced to maintain the balance in current distribution and provide the effects of reducing voltage drop at a specific portion of the electrode during the rapid charging and discharging, thereby extending the lifespan of the battery and improving the charging and discharging performance.

The electrode assembly 10 according to the present disclosure will be described in more detail.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}-D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹ _{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{(3-f)}Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The amount of the positive electrode active material is in a range of about 90 wt % to about 99.5 wt % on the basis of 100 wt % of the positive electrode active material layer, and the amount of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to some embodiments, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

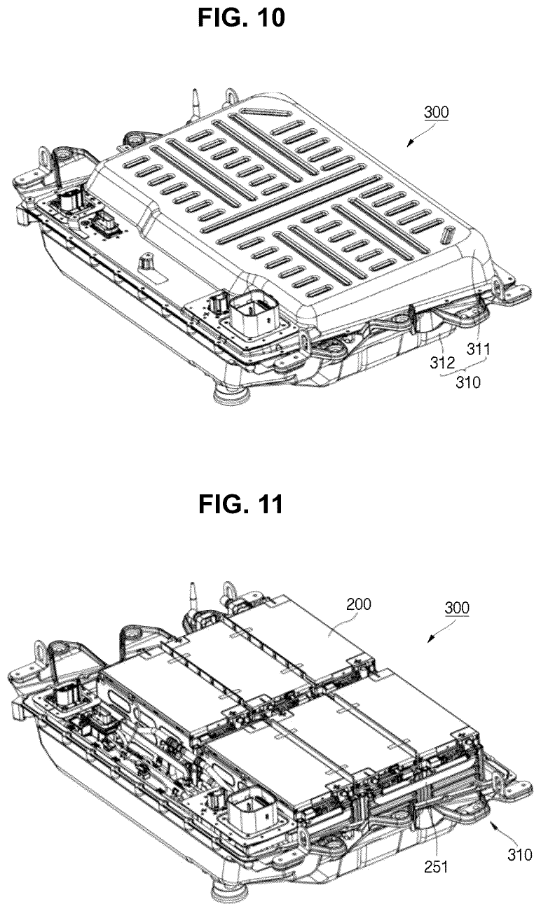

The batteries according to the above-described embodiments may be used to manufacture a battery pack. FIGS. 10 and 11 are perspective views showing a battery pack including a secondary battery according to some embodiments of the present disclosure. Referring to FIGS. 10 and 11, the battery pack 300 may include a plurality of battery modules 200 and a housing 310 to accommodate the plurality of battery modules 200. For example, the housing 310 may comprise a first and a second housing (i.e., a battery pack cover 311 and a pack frame 312) that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

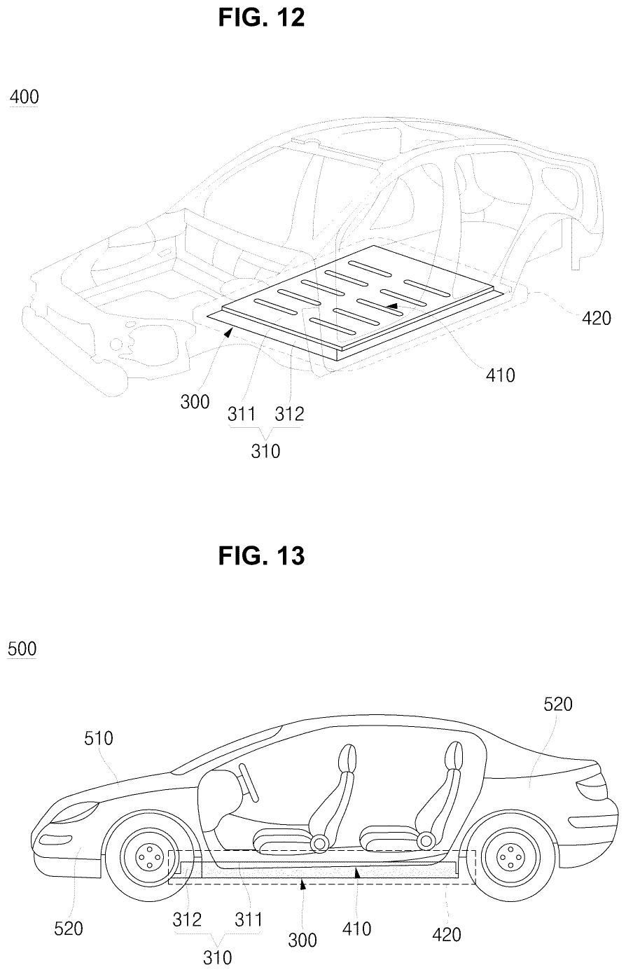

FIGS. 12 and 13 show a perspective view and a side view, respectively, of a vehicle including a battery pack according to some embodiments of the present disclosure.

In FIG. 12, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 13, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body 400.

According to the present disclosure, the positive electrode active materials having the different characteristics may be laminated on the specific area of the positive electrode base material to secure the high-power performance and the high-temperature storage characteristics, and thus, the stable performance may be exhibited in various applications requiring the high power, such as the power tools, the vacuum cleaners, and the drones.

In some embodiments, the active material laminated on the specific area of the positive electrode base material may be improved in composition and arrangement, which minimizes the difference in charge between the electrodes during the charging and discharging processes, and also improves the efficiency and stability of the battery. Additionally, the positive electrode active material laminated on the plurality of areas may be provided in thickness and position that minimizes the structural stress that may occur during the charging and reversing operations, while maintaining the uniformity of the electrode structure.

In some embodiments, the soft film may be applied to the pouch-type secondary battery and thus may be utilized in the battery products having the various forms. The soft film may further provide the stable power supply while maintaining the high energy density.

However, the effects achievable through the present invention are not limited to those described above, and other technical effects not mentioned can be clearly understood by those skilled in the art from the description of the invention provided above.

Although some embodiments of the present disclosure have been shown and described, it would be appreciated by those skilled in the art that various changes and modifications may be made to the above embodiments without departing from the principles and technical idea of the disclosure.

What is claimed is

1. A secondary battery comprising:
a positive electrode plate in which a first positive electrode active material and a second positive electrode active material are laminated on different areas of a positive electrode base material;
a negative electrode plate corresponding to the positive electrode plate; and
a separator between the positive electrode plate and the negative electrode plate,
wherein the first positive electrode active material has superior output characteristics compared to the second positive electrode active material, and
the second positive electrode active material has high-temperature storage characteristics compared to the first positive electrode active material.

2. The secondary battery as claimed in claim 1, further comprising a positive electrode tab connected to the positive electrode base material,
wherein the first positive electrode active material is laminated on a first area of the positive electrode base material connected to the positive electrode tab, and
wherein the second positive electrode active material is laminated on a second area below the first area.

3. The secondary battery as claimed in claim 2, wherein the first area is set along a width direction of the positive electrode base material, and
wherein the first area is positioned closer to the positive electrode tab than the second area is to the positive electrode tab.

4. The secondary battery as claimed in claim 2, wherein the first positive electrode active material is laminated along a width direction of the positive electrode base material, and
wherein the first positive electrode active material is positioned closer to the positive electrode tab than the second positive electrode active material is to the positive electrode tab.

5. The secondary battery as claimed in claim 1, wherein the first positive electrode active material comprises at least one of nickel-cobalt-aluminum oxide or nickel-cobalt-manganese oxide.

6. The secondary battery as claimed in claim 1, wherein the second positive electrode active material comprises lithium cobalt oxide.

7. The secondary battery as claimed in claim 2, further comprising:
a first active material layer in which the first positive electrode active material is laminated on the first area; and
a second active material layer in which the second positive electrode active material is laminated on the second area.

8. The secondary battery as claimed in claim 7, wherein a thickness of the first active material layer laminated on the positive electrode base material is thinner than a thickness of the second active material layer.

9. The secondary battery as claimed in claim 7, wherein a thickness of the first active material layer is about 70% to about 80% of the thickness of the second active material layer.

10. The secondary battery as claimed in claim 7, wherein a vertical length of the first active material layer is shorter than a vertical length of the second active material layer.

11. The secondary battery as claimed in claim 7, wherein, when a vertical length of the first active material layer is L1, and a vertical length of the second active material layer is L2, a conditional expression of L1<(L1+L2)*0.4 is satisfied.

12. A secondary battery comprising:
a case;
an electrode assembly accommodated in the case, the electrode assembly comprising a positive electrode plate, with the positive electrode plate including a first positive electrode active material and a second positive electrode active material are laminated on different areas of a positive electrode base material, a negative electrode plate corresponding to the positive electrode plate, and a separator between the positive electrode plate and the negative electrode plate; and
an electrode tab comprising a positive electrode tab connected to the positive electrode plate and a negative electrode tab connected to the negative electrode plate;,
wherein the first positive electrode active material has superior output characteristics compared to the second positive electrode active material, and
the second positive electrode active material has high-temperature storage characteristics compared to the first positive electrode active material.

13. The secondary battery as claimed in claim 12, wherein the case comprises a pouch formed from a soft film.

14. The secondary battery as claimed in claim 12, wherein the first positive electrode active material comprises at least one of nickel-cobalt-aluminum oxide or nickel-cobalt-manganese oxide.

15. The secondary battery as claimed in claim 12, wherein the second positive electrode active material comprises lithium cobalt oxide.

16. The secondary battery as claimed in claim 12, wherein the first positive electrode active material is laminated on a first area of the positive electrode base material connected to the positive electrode tab, and
wherein the second positive electrode active material is laminated on a second area below the first area.

17. The secondary battery as claimed in claim 16, further comprising:
a first active material layer in which the first positive electrode active material is laminated on the first area; and
a second active material layer in which the second positive electrode active material is laminated on the second area.

18. The secondary battery as claimed in claim 17, wherein the first active material layer is laminated on each of both surfaces of the positive electrode base material, and
the second active material layer is laminated on each of both the surfaces of the positive electrode base material.

19. The secondary battery as claimed in claim 17, wherein a thickness of the first active material layer is about 70% to about 80% of a thickness of the second active material layer.

20. The secondary battery as claimed in claim 17, wherein, when a vertical length of the first active material layer is L1, and a vertical length of the second active material layer is L2, a conditional expression of L1 <(L1+L2)*0.4 is satisfied.
